(19) United States
(12) Patent Application Publication
(10) Pub. No.: US 2024/0300774 A1
(43) Pub. Date: Sep. 12, 2024

(54) POST-PROCESSING DEVICE AND IMAGE FORMING SYSTEM

(71) Applicant: FUJIFILM Business Innovation Corp., Tokyo (JP)

(72) Inventors: Koji KAWANO, Kanagawa (JP); Takayuki FUKAMACHI, Kanagawa (JP); Eri FUKUI, Kanagawa (JP); Yuki MIZUNO, Kanagawa (JP)

(73) Assignee: FUJIFILM Business Innovation Corp., Tokyo (JP)

(21) Appl. No.: 18/430,622

(22) Filed: Feb. 1, 2024

(30) Foreign Application Priority Data
Mar. 9, 2023 (JP) 2023-036732
Mar. 27, 2023 (JP) 2023-050217
Sep. 13, 2023 (JP) 2023-148272
Sep. 25, 2023 (JP) 2023-160231
Sep. 26, 2023 (JP) 2023-163181

(51) Int. Cl. B65H 45/18; H04N 1/00

(52) U.S. Cl. CPC B65H 45/18; H04N 1/00639; B65H 2513/40; B65H 2701/13212

(57) ABSTRACT

A post-processing device includes: a loading section on which a bundle of recording media subjected to folding processing is loaded; a pushing section that moves in a thickness direction of the bundle of recording media, comes into contact with a surface, and pushes the bundle of recording media to form a folded portion; and a rotating section that starts an operation from a stopped state after the pushing section moves to a predetermined position, and sandwiches and rotates the folded portion of the bundle of recording media pushed by the pushing section to form a fold in the bundle of recording media.

### CROSS-REFERENCE TO RELATED APPLICATIONS

This application is based on and claims priority under 35 USC 119 from Japanese Patent Application No. 2023-148272 filed Sep. 13, 2023, Japanese Patent Application No. 2023-036732 filed Mar. 9, 2023, Japanese Patent Application No. 2023-050217 filed Mar. 27, 2023, Japanese Patent Application No. 2023-160231 filed Sep. 25, 2023, and Japanese Patent Application No. 2023-163181 filed Sep. 26, 2023.

### BACKGROUND

### (i) Technical Field

The present invention relates to a post-processing device and an image forming system.

### (ii) Related Art

For the purpose of strengthening folding of a recording material while avoiding occurrence of wrinkles, there is a related art document, which discloses an invention relating to an image forming apparatus including: a holding section that holds the recording material; an extruding member that comes into linear contact with the recording material held by the holding section and extrudes the contacted portion; and at least a pair of rotating members that are disposed on a side opposite to the extruding member with the recording material sandwiched therebetween, draw a part of the recording material extruded by the extruding member into between the pair of rotating members by rotating each of the pair of rotating members, and increase a force for sandwiching the part as the part is drawn.

### SUMMARY

In a case where a fold of a bundle of recording media is formed by using a pushing section and a rotating section, the bundle of recording media is extruded to the rotating section being rotating. Therefore, the timing, at which the bundle of recording media is drawn into the rotating section, becomes unstable. As a result, folding accuracy is reduced.

Aspects of non-limiting embodiments of the present disclosure relate to a post-processing device and an image forming system that improve the folding accuracy of the bundle of recording media as compared with a case where the bundle of recording media is pushed by the pushing section in a state where the rotating section is rotated.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a post-processing device including: a loading section on which a bundle of recording media subjected to folding processing is loaded; a pushing section that moves in a thickness direction of the bundle of recording media, comes into contact with a surface, and pushes the bundle of recording media to form a folded portion; and a rotating section that starts an operation from a stopped state after the pushing section moves to a predetermined position, and sandwiches and rotates the folded portion of the bundle of recording media pushed by the pushing section to form a fold in the bundle of recording media.

### BRIEF DESCRIPTION OF THE DRAWINGS

Exemplary embodiment(s) of the present invention will be described in detail based on the following figures, wherein:

FIG. 1 is a diagram showing an overall configuration example of an image forming system;

FIG. 2 is a diagram showing an example of a finisher unit;

FIG. 3 is a diagram showing a configuration example of a control section;

FIGS. 4A to 4C are diagrams showing an example of an end guide, where FIG. 4A is a diagram showing a state where a movable end guide is at one position, FIG. 4B is a diagram showing a state where the end guide is at another position, and FIG. 4C is a diagram showing a state where the end guide is closed by an opening-closing mechanism;

FIG. 5 is a view of a folding knife and folding rollers as viewed from above, where (A) of FIG. 5 is a view showing a state where the folding knife is retracted, and (B) of FIG. 5 is a view showing a state where the folding knife advances to the folding rollers side;

FIGS. 6A to 6D are diagrams showing a folding processing operation in the present exemplary embodiment, where FIG. 6A is a diagram showing a state at the start of the folding processing, FIG. 6B is a drawing in which a folding knife advances and comes into contact with a bundle of sheets, FIG. 6C shows a state where the folding knife further advances and the bundle of sheets comes into contact with the folding rollers, and FIG. 6D shows a state where the folding knife further advances and the folding rollers sandwiches the bundle of sheets to form the fold in the bundle of sheets;

FIGS. 7A and 7B are a diagram showing folding processing performed in a state where the end guide is open, where FIG. 7A is a diagram showing a state before the folding knife pushes the bundle of sheets, and FIG. 7B is a diagram showing a state where the folding knife pushes the bundle of sheets;

FIGS. 8A and 8B are diagrams showing folding processing performed in a state where the end guide is closed, where FIG. 8A is a diagram showing a state before the folding knife pushes the bundle of sheets, and FIG. 8B is a diagram showing a state where the folding knife pushes the bundle of sheets;

FIG. 9 is a diagram showing an outline of an operation of the center binding processing in the present exemplary embodiment;

FIG. 10 is a diagram showing an example of an intermediate position setting table;

FIG. 11 is a diagram showing an outline of an operation of the folding knife in the folding processing of the present exemplary embodiment; and

FIG. 12 is a diagram showing an outline of an operation of the folding rollers in the folding processing of the present exemplary embodiment.

### DETAILED DESCRIPTION

### Overall Configuration of Image Forming System

Hereinafter, an exemplary embodiment of the present invention will be described with reference to the accompanying drawings.

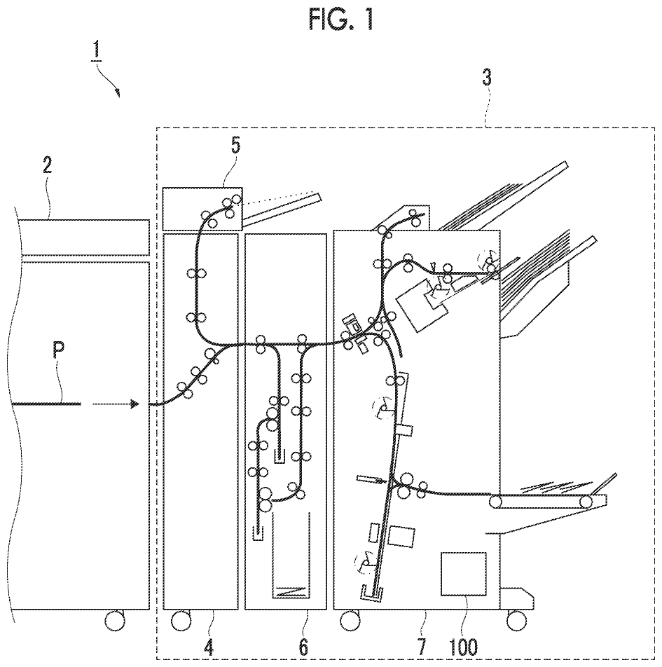

FIG. 1 is a diagram showing an overall configuration example of an image forming system 1.

FIG. 1 shows a state where the image forming system 1 is viewed from a front side of the image forming system 1. The image forming system 1 shown in the drawing includes an image forming apparatus 2 that forms an image on a sheet P that is an example of a recording medium, and a post-processing device 3 that executes processing on the sheet P on which an image is formed by the image forming apparatus 2. The image forming method in the image forming apparatus 2 is not particularly limited. In the image forming apparatus 2, for example, an electrophotographic method, an inkjet method, or the like is used to form an image on the sheet P.

### Configuration of Post-Processing Device

The post-processing device 3 is provided with a transporting unit 4, a laminating sheet supplying unit 5, a folding unit 6, and a finisher unit 7. The transporting unit 4 transports the sheet P output from the image forming apparatus 2 to the downstream side. The laminating sheet supplying unit 5 supplies a laminating sheet such as a thick sheet or a windowpane sheet as the sheet P transported by the transporting unit 4. Further, the post-processing device 3 is provided with a control section 100 that controls each unit of the post-processing device 3.

The folding unit 6 executes folding processing such as an inner tri-fold (C-fold) or an outer tri-fold (Z-fold) on the sheet P transported from the transporting unit 4. The finisher unit 7 is provided on the downstream side of the folding unit 6, and executes binding processing using staple processing and executes folding processing of forming a fold in the bundle of sheets.

### Configuration of Finisher Unit

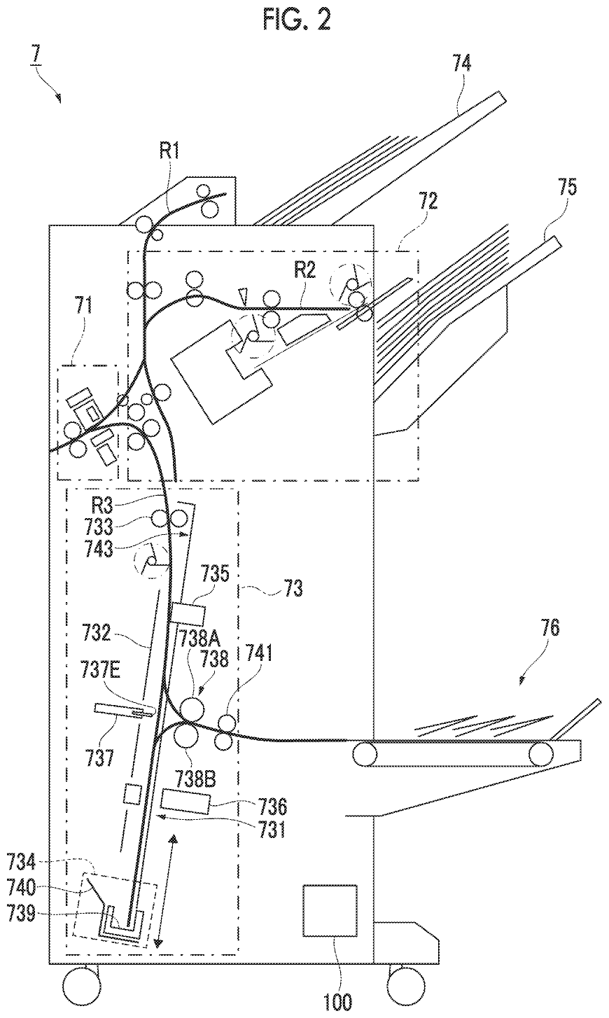

FIG. 2 is a diagram showing an example of the finisher unit 7.

FIG. 2 shows a state where the finisher unit 7 is viewed from a front side of the image forming system 1. As shown in FIG. 2, the finisher unit 7 is provided with a punching unit 71, an end binding stapler unit 72, and a center binding unit 73. The punching unit 71 executes punching processing on the sheet P. Further, the end binding stapler unit 72 executes processing of binding the ends of the bundle of sheets. Furthermore, the center binding unit 73 produces a booklet by performing binding processing or folding processing on, for example, a central part of the bundle of sheets.

Further, the finisher unit 7 is provided with a first tray 74, a second tray 75, and a third tray 76. The first tray 74 is loaded with the sheet P which is not processed by the finisher unit 7 or the sheet P which has been punched only. Furthermore, the second tray 75 is loaded with a bundle of sheets end-bound. Moreover, the third tray 76 is loaded with a booklet produced by performing the binding processing or the folding processing.

Further, the finisher unit 7 is provided with a first transport path R1, a second transport path R2, and a third transport path R3. The first transport path R1 is a path for transporting the sheet P that is not processed by the finisher unit 7 or the sheet P that is only punched, and is connected to the first tray 74. The second transport path R2 is a path for transporting the bundle of sheets for end binding, and is connected to the second tray 75. The third transport path R3 is a path for transporting the bundle of sheets to the center binding unit 73 and is connected to the third tray 76. The booklet produced by the center binding unit 73 is transported to the third tray 76.

### Configuration of Control Section

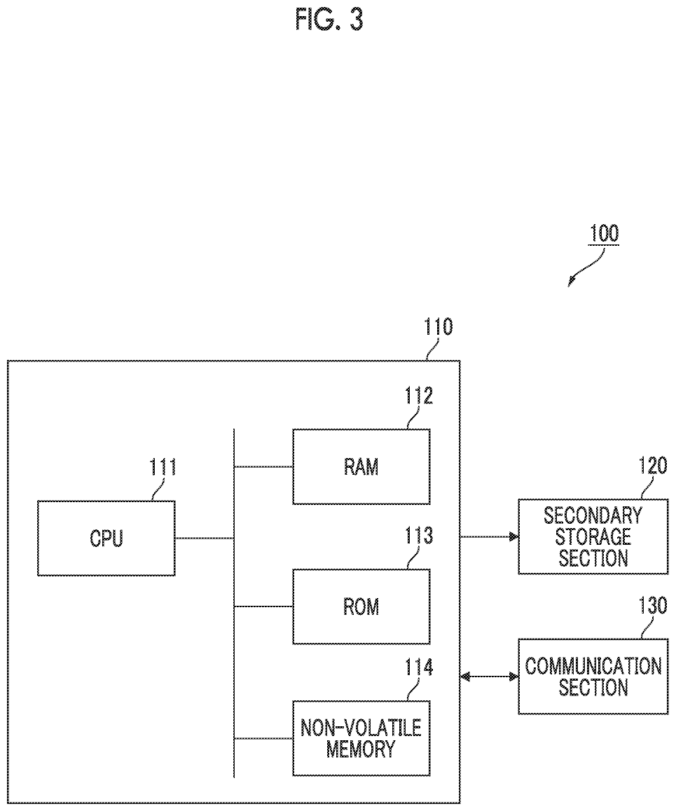

FIG. 3 is a diagram showing a configuration example of the control section 100.

The control section 100 includes an arithmetic processing section 110 that executes digital arithmetic processing according to a program, a secondary storage section 120 that records information such as a program, and a communication section 130 that transmits and receives information to and from an external device. The secondary storage section 120 is realized, for example, by a known information storage device such as a hard disk drive (HDD), a semiconductor memory, or a magnetic tape.

The arithmetic processing section 110 is provided with a CPU 111 as an example of a processor. Further, the arithmetic processing section 110 is provided with a RAM 112 used as a work memory or the like of the CPU 111 and a ROM 113 in which programs or the like executed by the CPU 111 are stored. Further, the arithmetic processing section 110 is provided with a non-volatile memory 114 that is configured to be rewritable and is able to hold data even in a case in which power supply is interrupted. The non-volatile memory 114 is configured by using, for example, a static random access memory (SRAM) backed up by a battery, a flash memory, or the like.

In the present exemplary embodiment, each processing is executed by the CPU 111 reading a program stored in the secondary storage section 120 or the ROM 113. The arithmetic processing section 110, the secondary storage section 120, and the communication section 130 are connected to each other through a bus or a signal line.

The program executed by the CPU 111 may be provided to the control section 100 in a state of being stored in a computer-readable recording medium such as a magnetic recording medium (magnetic tape, magnetic disk, or the like), an optical recording medium (optical disc or the like), an optical magnetic recording medium, or a semiconductor memory. Further, the program executed by the CPU 111 may be provided to the control section 100 by using a communication section such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

### Configuration of Center Binding Unit

Next, the center binding unit 73 will be described with reference to FIG. 2. In the present exemplary embodiment, as shown in FIG. 2, the center binding unit 73 is provided with a compile tray 731, a guide 732, feeding rollers 733, an end guide 734, a sheet aligning member 735, a stapler 736, a folding knife 737, and folding rollers 738. The control section 100 controls the operation of each section of the center binding unit 73. For example, the control section 100 controls an opening-closing mechanism (details will be described later) of the end guide 734, operations of the folding knife 737 and the folding rollers 738, and the like.

The compile tray 731 is loaded with the sheet P that is sequentially transported from the image forming apparatus 2. Thereby, a bundle of sheets made of one or a plurality of sheets P is generated. The number of sheets P in the bundle of sheets is specified by the setting of the printing processing to be executed. In the present specification, the “bundle of sheets” includes a bundle composed of one sheet P. The compile tray 731 is an example of the loading section for loading the bundle of sheets subjected to the folding processing.

The compile tray 731 has a plate-like sheet loading section 743 having a size corresponding to the sheet P. The sheet loading section 743 is provided with an opening portion (not shown in the drawing). The opening portion is, for example, a long hole having a length corresponding to the width of the sheet P and a width corresponding to a thickness of the folding knife 737 and stacked several sheets P. The opening portion is configured such that folding knife 737 and the bundle of several stacked sheets P pass therethrough.

The guide 732 is disposed at a position facing toward the compile tray 731 and guides the sheet P which is fed out from the feeding rollers 733. The guide 732 is disposed along the compile tray 731 with a gap between the guide 732 and the compile tray 731.

The feeding rollers 733 feed the sheet P transported from the image forming apparatus 2 toward the compile tray 731. In a case where the printing processing is executed on the plurality of sheets P, the sheet P is fed out by the feeding rollers 733 a number of times according to the number of printed sheets.

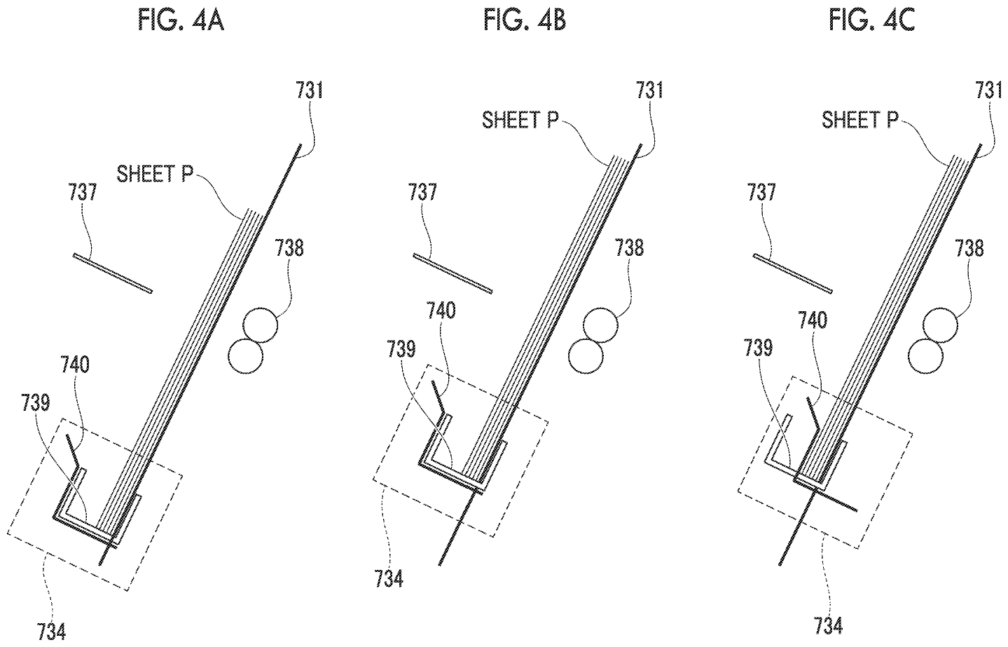

FIGS. 4A to 4C are diagrams showing an example of the end guide 734. FIG. 4A is a diagram showing a state where a movable end guide 734 is at one position, FIG. 4B is a diagram showing a state where the end guide 734 is at another position, and FIG. 4C is a diagram showing a state where the end guide 734 is closed by an opening-closing mechanism 740. The end guide 734 (refer to FIG. 2) is an example of a supporting section that supports the bundle of sheets. As shown in FIG. 4A, the end guide 734 has an abutting section 739 against which a lower end portion, which is one end portion of a bundle of sheets, abuts. The sheet P fed out by the feeding rollers 733 moves downward along the compile tray 731. Then, the abutting section 739 supports the lower end portion which is one end portion of the bundle of sheets.

Further, as shown in FIG. 4B, the end guide 734 moves in the up-down direction.

Thereby, the position of the bundle of sheets can be moved in accordance with the processing performed on the bundle of sheets. Specifically, the bundle of sheets can be placed at different positions depending on whether the binding processing is executed or the folding processing is executed. For example, in a case where the stapler 736 is positioned under the opening portion of the compile tray 731 as shown in FIG. 2, the end guide 734 first positions the central part of the bundle of sheets such that the central part corresponds to the stapler 736. Then, the binding processing is executed on the bundle of sheets. Next, the end guide 734 is moved upward such that the central part of the bound bundle of sheets is positioned to correspond to the opening portion of the compile tray 731. Then, the folding processing is performed on the bundle of sheets.

Further, the end guide 734 includes an opening-closing mechanism 740 that is able to be opened and closed in the thickness direction of the bundle of sheets and is able to hold the bundle of sheets by applying pressure to sandwich the bundle of sheets. More specifically, as shown in FIG. 4A, in a state where the end guide 734 is opened by the opening-closing mechanism 740 (hereinafter, referred to as an “opened state”), only the bundle of sheets is placed on the end guide 734. Therefore, the bundle of sheets is not sandwiched and held. On the other hand, as shown in FIG. 4C, in a state where the end guide 734 is closed by the opening-closing mechanism 740 (hereinafter, referred to as a “closed state”), the end guide 734 holds the bundle of sheets by applying a predetermined pressure to the bundle of sheets. The predetermined pressure may be a pressure such that the bundle of sheets sandwiched by the end guide 734 is slidable in the folding processing using the folding knife 737 and the folding rollers 738 to be described later. Here, the term “slidable” means that the bundle of sheets can be slid and moved. In the present exemplary embodiment, the end guide 734 is closed in a case where the fold is formed in the bundle of sheets by the folding knife 737 and the folding rollers 738, and holds the bundle of sheets.

The sheet aligning member 735 is a tamper that aligns bundles of sheets by pushing (tamping) the bundles of sheets loaded on the compile tray 731. Further, the sheet aligning member 735 may have a configuration in which the bundle of sheets is pushed from the above to align the bundle of sheets in the up-down direction together with the abutting section 739 of the end guide 734. The sheet aligning member 735 may perform an operation of aligning the sheets P each time the sheets P are transported onto the compile tray 731, or the number of sheets P determined by the setting of the printing processing may be loaded on the compile tray 731. Thereafter, sheet alignment may be performed.

The stapler 736 executes binding processing on the bundle of sheets loaded on the compile tray 731. The stapler 736 is an example of the binding mechanism. In the present exemplary embodiment, the binding processing of binding the bundle of sheets using a binding needle will be described. However, instead of using the binding needle as the binding processing, for example, a mechanism of crimping and binding sheets to each other may be used.

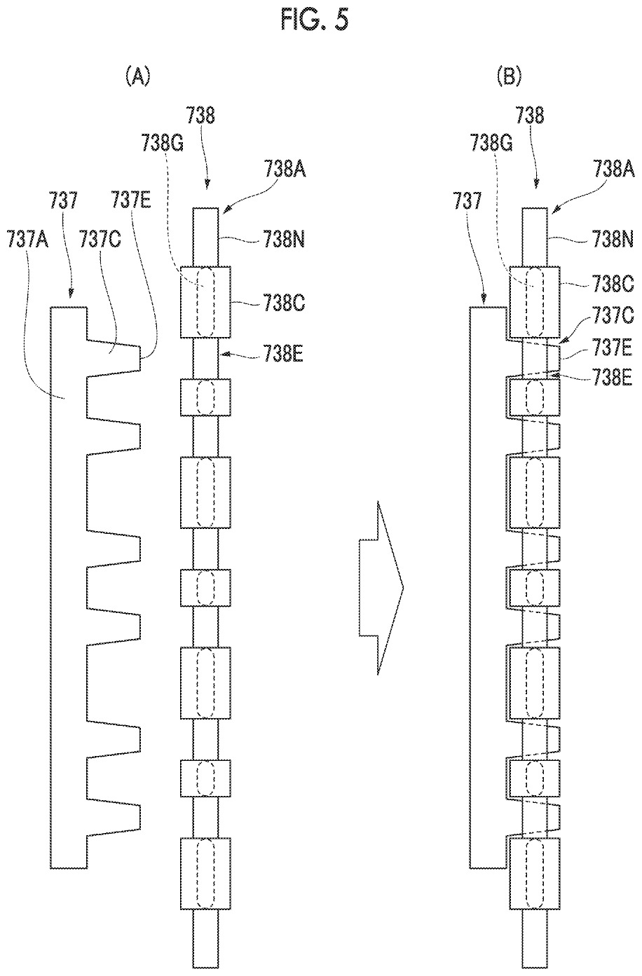

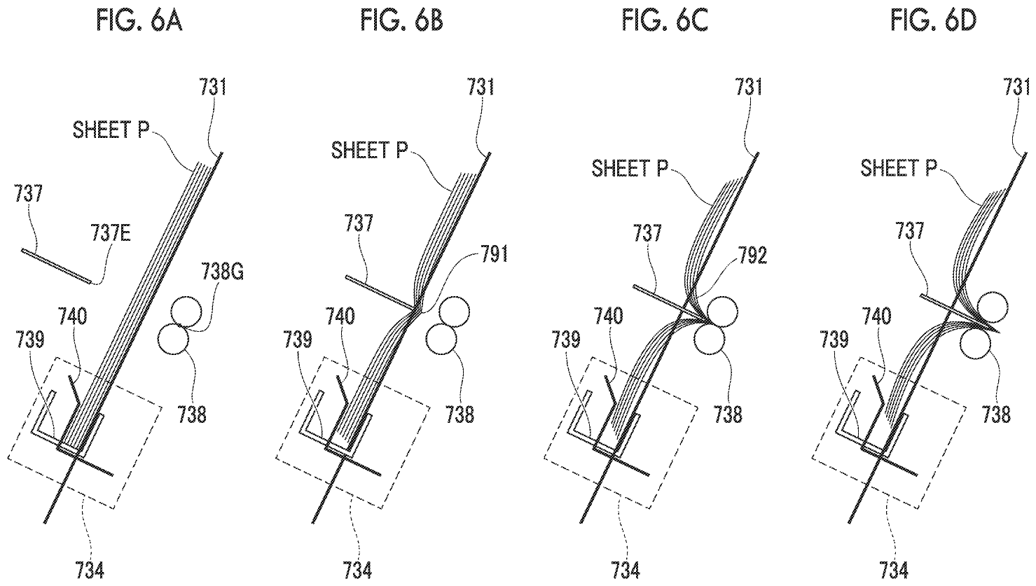

The folding knife 737 is an example of the pushing section that pushes the bundle of sheets. As shown in FIG. 2, the folding knife 737 is disposed at a position facing toward the compile tray 731. Further, in the present exemplary embodiment, the folding knife 737 is configured to include a base portion 737A (refer to FIG. 5) having a length corresponding to an opening portion of the compile tray 731, and a plurality of protruding portions 737C (refer to FIG. 5) protruding from the base portion 737A toward the compile tray 731. Further, the protruding portion 737C has an apical end portion 737E. The folding knife 737 is configured to be movable back and forth toward the compile tray 731 with the width of the sheet P. In a state at the retraction position, the folding knife 737 is disposed at a position that does not touch the bundle of sheets loaded on the compile tray 731. The folding knife 737 passes through the opening portion of the compile tray 731 and reaches the folding rollers 738 provided on the rear side of the compile tray 731 in a state where the folding knife 737 is advanced with respect to the compile tray 731. Therefore, in a case where the folding knife 737 advances toward the compile tray 731 in a state where the bundle of sheets is loaded on the compile tray 731, the folding knife 737 comes into contact with the surface of the bundle of sheets and pushes the bundle of sheets toward the opening portion of the compile tray 731. Thereby, the bundle of sheets is folded at a position at which the folding knife 737 pushes the sheets to form a folded portion 791 (refer to FIGS. 6A to 6D). In the present exemplary embodiment, the control section 100 controls the operation of the folding knife 737.

The folding rollers 738 are an example of the rotating section that forms the fold in the bundle of sheets. As shown in FIG. 2, the folding rollers 738 are disposed on the side opposite to the folding knife 737 with the compile tray 731 interposed therebetween. Further, in the present exemplary embodiment, the folding rollers 738 are configured by a pair of rollers disposed vertically. As the pair of rollers, a first folding roller 738A positioned on the upper side and a second folding roller 738B positioned on the lower side are provided. The folding rollers 738 form the fold in a bundle of sheets by rotating a folded portion 791 formed by the folding knife 737 and sandwiching the sheet extruded from an opening portion of the compile tray 731. Furthermore, the folding rollers 738 are rotated while pushing the bundle of sheets by the first folding roller 738A and the second folding roller 738B, and the bundle of sheets is transported. In the present exemplary embodiment, the control section 100 controls the operation of the folding rollers 738. Moreover, in the present exemplary embodiment, transporting rollers 741 for transporting the bundle of sheets to the third tray is provided on the downstream side of the folding rollers 738 in the transport direction.

### Positional Relationship Between Folding Knife and Folding Rollers

(A) and (B) of FIG. 5 are views of the folding knife 737 and the folding rollers 738 as viewed from above. (A) of FIG. 5 is a diagram showing a state where the folding knife 737 is retracted, and (B) of FIG. 5 is a diagram showing a state where the folding knife 737 is advanced toward the folding rollers 738. Since the folding rollers 738 are viewed from above in (A) and (B) of FIG. 5, only the first folding roller 738A is shown in the drawing and the second folding roller 738B is not shown.

As shown in (A) of FIG. 5, each of the first folding roller 738A and the second folding roller 738B (not shown in FIG. 5) constituting the folding rollers 738 is provided with a columnar rotating shaft 738N and a cylindrical elastic body 738C mounted on an outer peripheral surface of the rotating shaft 738N. The elastic body 738C is made of, for example, a rubber or a soft resin. A plurality of elastic bodies 738C are provided, and the elastic bodies 738C are provided in a state of being aligned in the axial direction of the rotating shaft 738N. A gap 738E is provided between the elastic bodies 738C adjacent to each other. Further, in the present exemplary embodiment, the first folding roller 738A and the second folding roller 738B are in contact with each other at the contact portion 738G (refer to (A) of FIG. 5).

The folding knife 737 (refer to (A) of FIG. 5) is provided with the base portion 737A extending in the axial direction of the folding rollers 738 and the protruding portions 737C protruding from the base portion 737A toward the folding rollers 738. The plurality of protruding portions 737C are provided at intervals so as not to overlap with each other along the longitudinal direction of the folding knife 737. It should be noted that the folding knife 737 shown in FIG. 5 is an example, and the number of protruding portions 737C and the positions of the protruding portions 737C are not limited thereto.

As shown in (B) of FIG. 5, in a case where the folding knife 737 moves toward the folding rollers 738, the protruding portions 737C of the folding knife 737 enter the gaps 738E of the elastic bodies 738C of the folding rollers 738. Then, the apical end portion 737E of the protruding portion 737C passes between a rotating shaft 738N of the first folding roller 738A (refer to (B) of FIG. 5) and a rotating shaft 738N of the second folding roller 738B (not shown in (B) of FIG. 5). Subsequently, in a case where the folding knife 737 further advances, the apical end portion 737E of the protruding portion 737C moves to a position exceeding the contact portion 738G between the first folding roller 738A and the second folding roller 738B.

### Folding Processing Operation

FIGS. 6A to 6D are diagrams showing a folding processing operation in the present exemplary embodiment. FIG. 6A is a diagram showing a state at the start of the folding processing. FIG. 6B is a drawing in which the folding knife 737 advances and comes into contact with a bundle of sheets. FIG. 6C shows a state where the folding knife 737 further advances and the bundle of sheets comes into contact with the folding roller 738. FIG. 6D shows a state where the folding knife 737 further advances and the folding rollers 738 sandwiches the bundle of sheets to form the fold in the bundle of sheets.

In the folding processing, the operations of the folding knife 737 and the folding rollers 738 are controlled independently. Specifically, first, only the folding knife 737 operates to push the bundle of sheets, and then, together with the folding knife 737, the folding rollers 738 operate to form a fold in the bundle of sheets. Referring to FIGS. 6A to 6D, as shown in FIG. 6A, at the start of the folding processing, the folding knife 737 is positioned in the stopped state at the initial position in the center binding unit 73. In a case where the folding processing is started, first, the folding knife 737 moves toward the bundle of sheets. At this point, the folding rollers 738 are stopped.

Next, as shown in FIG. 6B, the folding knife 737 comes into contact with the bundle of sheets and pushes the bundle of sheets to form the folded portion 791 in the bundle of sheets. Even at this point, the folding rollers 738 are stopped. Then, in a case where the folding knife 737 further advances, as shown in FIG. 6C, the folding rollers 738 come into contact with the surface 792 on the side opposite to the surface with which the folding knife 737 of the bundle of sheets is in contact.

Thereafter, the folding knife 737 further advances, and the folding rollers 738 start rotating. As the folding knife 737 advances, as shown in FIG. 6D, the apical end portion 737E of the folding knife 737 moves to a position exceeding the contact portion 738G between the first folding roller 738A and the second folding roller 738B while pushing the bundle of sheets. Then, the bundle of sheets is folded by being pushed by the folding knife 737 and being sandwiched by the rotating folding rollers 738 from the surface 792 side. The folding knife 737 advances to a position to be described later, and then retracts to return to the initial position. On the other hand, the folding rollers 738 further rotate and transport the bundle of folded sheets to the downstream side while pushing the bundle of folded sheets.

### Operation of End Guide

It has already been described that the end guide 734 includes the opening-closing mechanism 740. Here, the center binding processing for the bundle of sheets loaded on the compile tray 731 will be described. The opening and closing operations of the end guide 734 in this center binding processing will be described. In the center binding processing, first, binding processing using the stapler 736 is performed on the bundle of sheets, and then the folding processing is executed. It should be noted that the operation of each section of the center binding unit 73 in the center binding processing is realized by the CPU 111 reading the program, which is stored in the secondary storage section 120 or the ROM 113, into the RAM 112 and executing the operation.

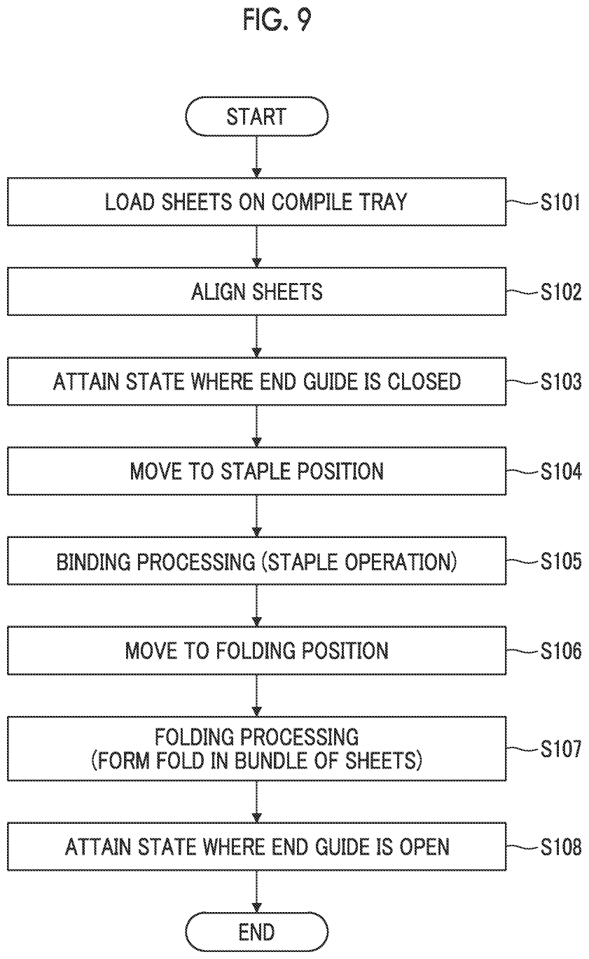

FIG. 9 is a diagram showing an outline of an operation of the center binding processing in the present exemplary embodiment.

First, as the operation before the start of the center binding processing, the sheet P, which is fed out from the feeding rollers 733, is loaded on the compile tray 731 (S101). Next, the sheet aligning member 735 pushes the bundle of sheets on the compile tray 731 to align the sheet (S102).

In a case where the center binding unit 73 starts the center binding processing, first, the opening-closing mechanism 740 closes the end guide 734 (S103). Next, the end guide 734 moves such that the binding position of the bundle of sheets becomes the staple position by the stapler 736 (S104). The binding position of the bundle of sheets is, for example, a central part of the sheet P. After the end guide 734 is moved, the stapler 736 binds the bundle of sheets (S105). In such a case, since the end guide 734 is closed in S103, the end guide 734 pushes the bundle of sheets with a certain amount of pressure. For this reason, it is possible to prevent the bundle of sheets from being in disorder since the stapler 736 comes into contact with the bundle of sheets in the binding processing.

After the binding processing is executed, the end guide 734 moves such that a position at which a fold of the bundle of sheets is formed (hereinafter, referred to as a “folding position”) is a position facing toward the apical end portion 737E of the folding knife 737 (S106). The folding position of the bundle of sheets is, for example, the central part of the sheet P that is the same as the binding position. After the end guide 734 is moved, the folding knife 737 and the folding rollers 738 perform the folding processing on the bundle of sheets (S107). In the folding processing, the folding knife 737 folds the bundle of sheets while pushing the folding position of the bundle of sheets, and advances the bundle of sheets from the opening portion of the compile tray 731 to the folding rollers 738. Then, the folding rollers 738 transport the bundle of folded sheets to the downstream side while further folding the bundle of folded sheets with the bundle of folded sheets sandwiched therebetween. In such a case, the end guide 734 is kept in the closed state. In the closed state, the end guide 734 pushes the bundle of sheets with such a pressure that the bundle of sheets slides due to a force in a case where the folding knife 737 pushes the bundle of sheets and folds the bundle of sheets while passing through the opening portion. For this reason, in an operation in which the folding knife 737 pushes and folds the bundle of sheets in the folding processing, it is possible to prevent the bundle of sheets from floating and causing disorder.

In a case where the folding processing is completed and the folding rollers 738 transport the bundle of sheets, the opening-closing mechanism 740 opens the end guide 734 (S108). It should be noted that, in the above-mentioned operation example, the binding processing is executed in S104 and S105, and then the folding processing is executed in S106 and S107. However, in a case where only the folding processing is executed without performing the binding processing, S104 and S105 are omitted. Also in such a case, the end guide 734 is closed in S103, the folding processing of S106 and S107 is performed while the closed state is kept, and the end guide 734 is opened in S108 after the folding processing is completed.

Further, in the above-mentioned operation example, the binding processing and the folding processing are performed after the end guide 734 is closed. Here, the pressure, at which the end guide 734 pushes the bundle of sheets, is such that the bundle of sheets slides. However, since the bundle of sheets does not slide in the binding processing, the bundle of sheets may be pushed with a stronger pressure. That is, the bundle of sheets may be pushed with the identical pressure to the extent that the bundle of sheets slides through the binding processing and the folding processing. In addition, the bundle of sheets may be pushed with such a strength that does not move in the binding processing or may be pushed with such a strength that the bundle of sheets slides, the strength being weaker than that in the folding processing.

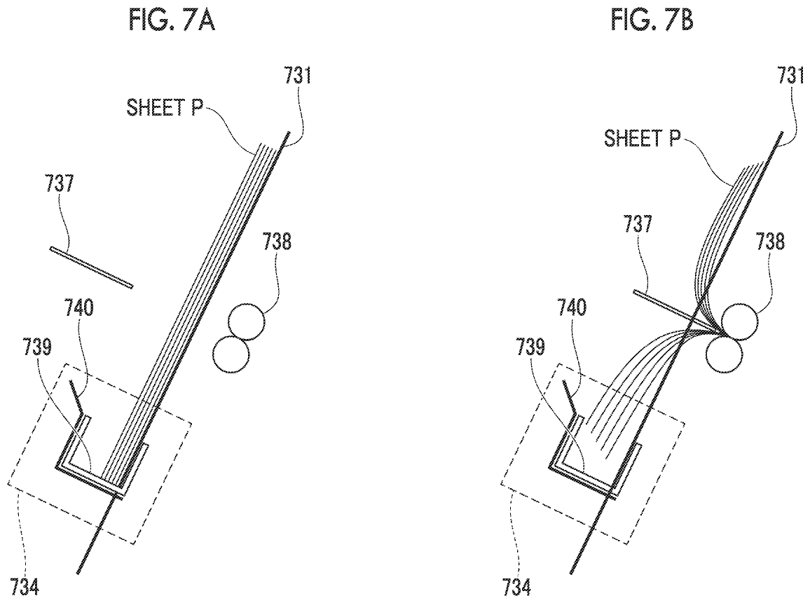

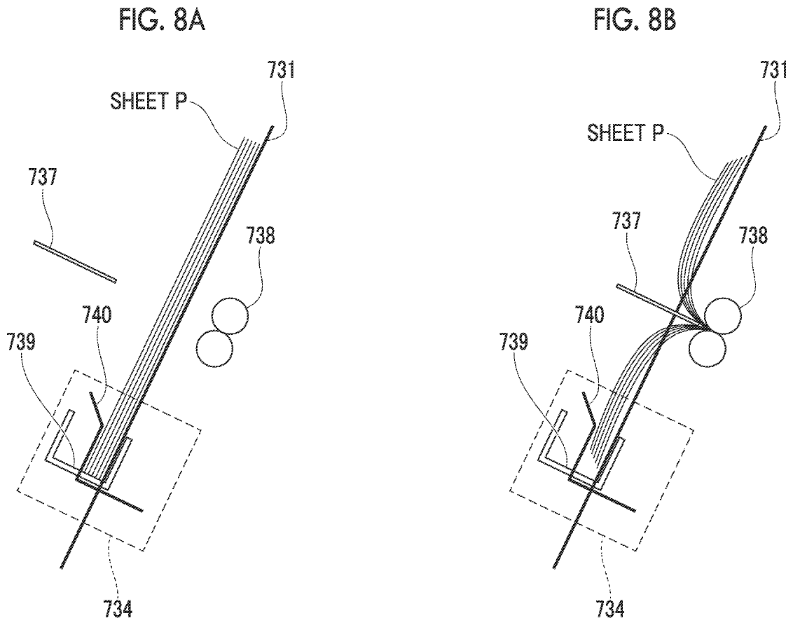

As described above, in the present exemplary embodiment, the closed state of the end guide 734 is kept until the folding processing is completed in the center binding processing. This point will be further described with reference to the drawings. FIGS. 7A and 7B are a diagrams showing the folding processing performed in the opened state of the end guide 734. FIG. 7A is a diagram showing a state before the folding knife 737 pushes the bundle of sheets, and FIG. 7B is a diagram showing a state where the folding knife 737 pushes the bundle of sheets. FIGS. 8A and 8B are diagrams showing the folding processing performed in the closed state of the end guide 734. FIG. 8A is a diagram showing a state before the folding knife 737 pushes the bundle of sheets, and FIG. 8B is a diagram showing a state where the folding knife 737 pushes the bundle of sheets.

As shown in FIGS. 7A and 7B, in a case where the folding processing is executed with the end guide 734 in the opened state, the folding knife 737 deflects the bundle of sheets folded by pushing the bundle of sheets, such that the bundle of sheets is in a state of floating from the compile tray 731. For this reason, the sheet P of the bundle of sheets may be misaligned due to the force of pushing performed by the folding knife 737 or the force of sandwiching performed by the folding rollers 738, and the position of the fold of the bundle of sheets is not stable. On the other hand, as shown in FIGS. 8A and 8B, in a case where the folding processing is executed with the end guide 734 in the closed state, the folding knife 737 may push the bundle of sheets. Even in such a case, the end guide 734 pushes the bundle of sheets. Therefore, the bundle of sheets is not in a state of floating from the compile tray 731. Therefore, even in a case where the folding knife 737 pushes the bundle of sheets or the force of sandwiching performed by the folding rollers 738 acts on the bundle of sheets, the sheet P of the bundle of sheets is not misaligned, and the position of the fold of the bundle of sheets is stabilized.

Next, details of the operation outline of the folding processing will be described. As described with reference to FIGS. 6A to 6D, in the folding processing, the operations of the folding knife 737 and the folding rollers 738 are independently controlled. Therefore, the operation of the folding knife 737 and the operation of the folding rollers 738 in the folding processing will be separately described. The operation of the folding knife 737 is performed in two steps including a first step in which only the folding knife 737 operates and a second step in which the folding knife 737 operates together with the folding rollers 738. The operation of the folding rollers 738 is performed together with the operation in the second step of the folding knife 737.

In the first operation of the folding knife 737, the folding knife 737 moves to a position determined on the basis of the amount of movement from the initial position (hereinafter, referred to as an “intermediate position”). The intermediate position is, for example, a position at which the surface 792 of the bundle of folded sheets is pushed by the folding knife 737 and comes into contact with the folding rollers 738. In a case where the folding rollers 738 start the operation after the surface 792 of the bundle of sheets and the folding rollers 738 come into contact with each other, the sheet P on the side of the surface 792 of the bundle of sheets is suppressed from being wound into the folding rollers 738 earlier than the other sheets P.

Here, the position of the folding knife 737 where the bundle of sheets and the folding rollers 738 come into contact with each other is different depending on the conditions of the number of loaded sheets P and the basis weight of the sheet P subjected to folding processing. For example, different types of sheet P have different thicknesses even for the bundle of sheets of the same number of sheet P. Further, even in the same type of sheet P, the thickness of the bundle of sheets varies depending on the size of the number of loaded sheets. Therefore, the amount of movement for specifying the intermediate position is adjusted on the basis of the conditions of the number of loaded sheets P and the basis weight of the sheets P subjected to folding processing.

For example, in the present exemplary embodiment, an intermediate position setting table, in which the number of loaded sheets P and the basis weight of the sheet P are associated with the intermediate position in the movement of the folding knife 737, is provided in advance. The intermediate position setting table is retained in the secondary storage section 120 (refer to FIG. 3) or the like. Then, at the time of executing the folding processing, the control section 100 (refer to FIG. 3) specifies an intermediate position corresponding to the number of sheets P and the basis weight of the sheets P in the bundle of sheets to be processed, with reference to the intermediate position setting table, and calculates the amount of movement of the folding knife 737.

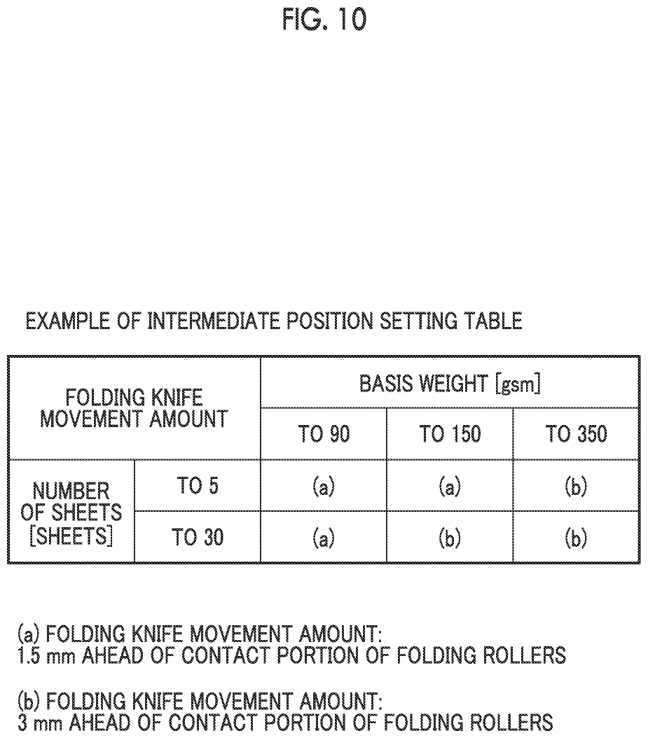

FIG. 10 is a diagram showing an example of the intermediate position setting table. In the example shown in FIG. 10, as the intermediate positions, the following positions are set: (a) a position of the apical end portion 737E of the folding knife 737 at 1.5 mm ahead of the contact portion 738G of the folding rollers 738; and (b) a position of the apical end portion 737E of the folding knife 737 at 3 mm ahead of the contact portion 738G of the folding rollers 738. Then, for example, a correspondence relationship between the set intermediate position and a combination of the sheet P and the basis weight is defined as follows: (a) a reference position in a case where the basis weight of the sheet P is equal to or less than 90 gsm and the number of loaded sheets is equal to or less than 5; (b) a reference position in a case where the basis weight of the sheet P is equal to or greater than 91 gsm and the number of loaded sheets is equal to or greater than 6; and the like. In the operation in the first step of the folding processing, the control section 100 controls the operation of the folding knife 737 by setting the amount of movement of the folding knife 737 from the initial position to the intermediate position which is specified by the intermediate position setting table. It should be noted that the combination of the number of loaded sheets and the basis weight shown in the intermediate position setting table in FIG. 10 and the setting values of the intermediate positions shown in (a) and (b) are merely examples and are not limited to values shown in the drawings.

### Outline of Operation of Folding Processing

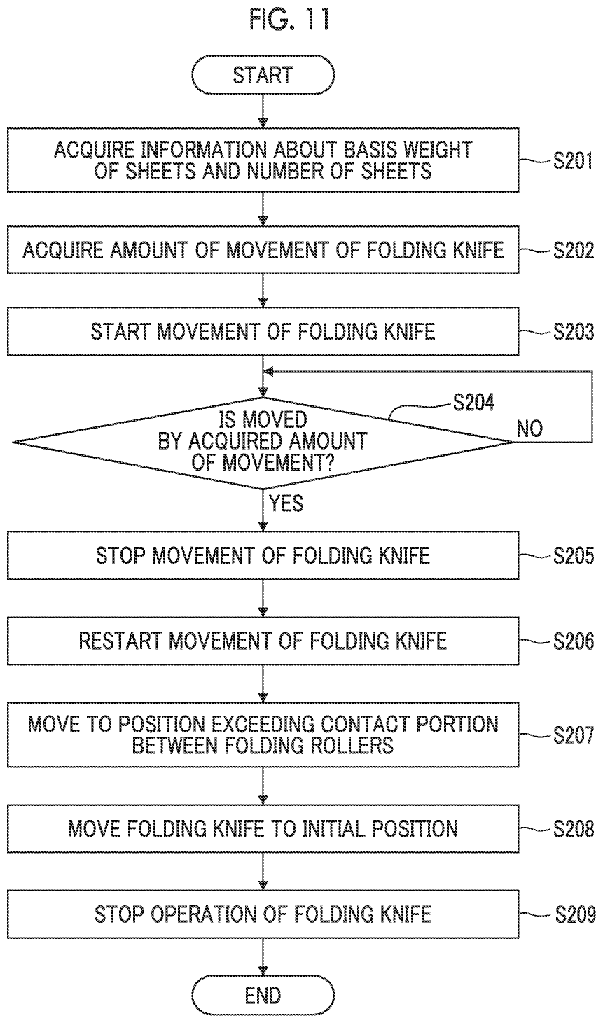

FIG. 11 is a diagram showing an outline of the operation of the folding knife 737 in the folding processing of the present exemplary embodiment.

In a case where the folding processing is executed in the present exemplary embodiment, first, the control section 100 acquires information about the basis weight of the sheet P and the number of sheets P (S201). The information about the basis weight is acquired, for example, from the information about the printing setting in the image forming apparatus 2. Specifically, the basis weight of the sheet P is specified on the basis of the information about the type of the sheet P designated in the printing setting. Further, for example, the information about the number of sheets may be extracted from the information about the printing setting in the image forming apparatus 2, or the image forming apparatus 2 may be configured to be provided with a counter for measurement.

Next, the control section 100 acquires the amount of movement of the folding knife 737 on the basis of the information about the intermediate position with reference to the intermediate position setting table using the acquired information about the basis weight and the number of sheets (S202). Next, the control section 100 starts the operation of the folding knife 737 (S203). Then, the control section 100 moves the folding knife 737 on the basis of the acquired amount of movement, and then stops the operation of the folding knife 737 (YES in S204, S205). Up to this point is the operation in the first step.

Thereafter, the control section 100 shifts to the operation in the second step and restarts the operation of the folding knife 737 in the stopped state (S206). In the operation in the second step, the control section 100 moves the folding knife 737 to a position at which the apical end portion 737E of the folding knife 737 exceeds the contact portion 738G between the first folding roller 738A and the second folding roller 738B (S207). Thereafter, the control section 100 moves the folding knife 737 to the initial position and stops the operation of the folding knife 737 (S208, S209).

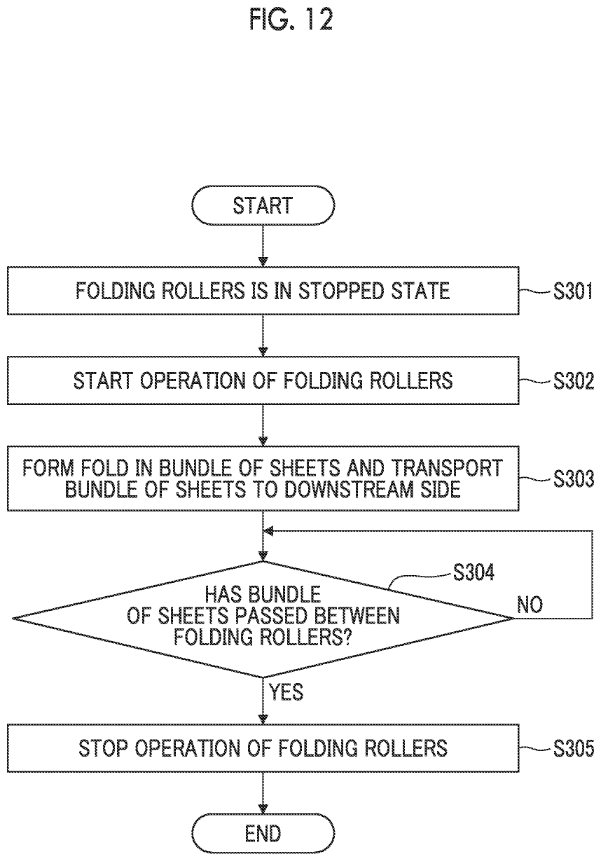

FIG. 12 is a diagram showing an outline of the operation of the folding rollers 738 in the folding processing of the present exemplary embodiment.

The folding rollers 738 are stopped until the operation in the first step of the folding knife 737 is completed (S301). Then, after the folding knife 737 moves to the intermediate position and stops, the control section 100 starts the operation of the folding rollers 738 together with the start of the operation in the second step of the folding knife 737 (S302). It should be noted that the operation of the folding knife 737 in the second step (FIG. 11, S206) and the operation of the folding rollers 738 (S302) are started at the same time.

The folding rollers 738 sandwich the folded portion 791 of the bundle of sheets and rotate to form the fold in the bundle of sheets, and transport the bundle of sheets to the downstream side (S303). Then, after the bundle of sheets has passed between the folding rollers 738, the control section 100 stops the operation of the folding rollers 738 (YES in S304, S305).

The folding processing is realized by the operation of the folding knife 737 described with reference to FIG. 11 and the operation of the folding rollers 738 described with reference to FIG. 12, and a booklet is produced by a series of the operations.

Although the exemplary embodiment of the present invention has been described above, the technical scope of the exemplary embodiment of the present invention is not limited to the above-mentioned exemplary embodiment. For example, in the present exemplary embodiment, in order to calculate the amount of movement of the folding knife 737, the information about the number of loaded sheets P and the basis weight of the sheet P is used. However, the present invention is not limited thereto. For example, in addition to the information about the number of loaded sheets P and the basis weight of the sheet P, the hardness of the sheet P, the surface state of the sheet P, and the like may be used. The condition for determining the amount of movement of the folding knife 737 may be any condition that affects the fold formation of the sheet.

Further, the present exemplary embodiment has described the aspect in which the operation of the folding knife 737 is temporarily stopped after being moved to a predetermined position and the operation is restarted together with the folding rollers 738. However, in a case where the operation of the folding knife 737 is restarted, the aspect, in which the operation of the folding knife 737 is started slightly earlier than the operation of the folding rollers 738, may be adopted. Thereby, it is possible to prevent the sheet P on the side of the surface 792 of the bundle of sheets from being sandwiched by the folding rollers 738 prior to the other sheet P.

On the other hand, the folding knife 737 may adopt an aspect in which the operation is not stopped in a case where the folding knife 737 moves to the predetermined position. In such a case, the control section 100 is able to realize the present aspect by performing control for starting the operation of the folding rollers 738 at the same time as the folding knife 737 moves to the predetermined position.

Further, in a case of forming the fold in the bundle of sheets, the pushing speed, at which the folding knife 737 pushes the bundle of sheets, may be set to be faster than the rotation speed at which the folding rollers 738 rotate while sandwiching the folded portion 791 of the bundle of sheets. Thereby, it is possible to prevent the sheet P on the side of the surface 792 of the bundle of sheets from being sandwiched by the folding rollers 738 prior to the other sheet P. In addition, various modifications and alternative configurations are involved in the present invention without departing from the technical scope of the present invention.

### Supplementary Notes

(((1)))

A post-processing device comprising:
a loading section on which a bundle of recording media subjected to folding processing is loaded;
a pushing section that moves in a thickness direction of the bundle of recording media, comes into contact with a surface, and pushes the bundle of recording media to form a folded portion; and
a rotating section that starts an operation from a stopped state after the pushing section moves to a predetermined position, and sandwiches and rotates the folded portion of the bundle of recording media pushed by the pushing section to form a fold in the bundle of recording media.

(((2)))

The post-processing device according to (((1))),
wherein the predetermined position is determined on the basis of an amount of movement of the pushing section from an initial position.

(((3)))

The post-processing device according to (((2))),
wherein the amount of movement is determined on the basis of the number of loaded recording media and a basis weight of the recording media.

(((4)))

The post-processing device according to (((2))) or (((3))),
wherein the pushing section starts the operation after the amount of movement is determined.

(((5)))

The post-processing device according to any one of (((1))) to (((4))),
wherein the pushing section stops at the predetermined position and then starts the operation together with the rotating section.

(((6)))

The post-processing device according to any one of (((1))) to (((5))),
wherein the pushing section moves to the predetermined position, and stops by the surface of the bundle of recording media coming into contact with the rotating section in the stopped state, and thereafter the movement of the pushing section and the operation of the rotating section are started.

(((7)))

The post-processing device according to any one of (((1))) to (((6))),
wherein in a case of forming the fold in the bundle of recording media, a pushing speed at which the pushing section pushes the bundle of recording media is faster than a rotation speed at which the rotating section sandwiches and rotates the folded portion of the bundle of recording media.

(((8)))

An image forming system comprising: an image forming apparatus that forms an image on a recording medium; and
the post-processing device according to any one of claims (((1))) to (((7))) that executes post-processing on the recording medium on which the image forming apparatus forms the image.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A post-processing device comprising:
a loading section on which a bundle of recording media subjected to folding processing is loaded;
a pushing section that moves in a thickness direction of the bundle of recording media, comes into contact with a surface, and pushes the bundle of recording media to form a folded portion; and
a rotating section that starts an operation from a stopped state after the pushing section moves to a predetermined position, and sandwiches and rotates the folded portion of the bundle of recording media pushed by the pushing section to form a fold in the bundle of recording media.

2. The post-processing device according to claim 1,
wherein the predetermined position is determined on the basis of an amount of movement of the pushing section from an initial position.

3. The post-processing device according to claim 2,
wherein the amount of movement is determined on the basis of the number of loaded recording media and a basis weight of the recording media.

4. The post-processing device according to claim 3,
wherein the pushing section starts the operation after the amount of movement is determined.

5. The post-processing device according to claim 1,
wherein the pushing section stops at the predetermined position and then starts the operation together with the rotating section.

6. The post-processing device according to claim 5,
wherein the pushing section moves to the predetermined position, and stops by the surface of the bundle of recording media coming into contact with the rotating section in the stopped state, and thereafter the movement of the pushing section and the operation of the rotating section are started.

7. The post-processing device according to claim 5,
wherein in a case of forming the fold in the bundle of recording media, a pushing speed at which the pushing section pushes the bundle of recording media is faster than a rotation speed at which the rotating section sandwiches and rotates the folded portion of the bundle of recording media.

8. An image forming system comprising:
an image forming apparatus that forms an image on a recording medium; and
the post-processing device according to claim 1 that executes post-processing on the recording medium on which the image forming apparatus forms the image.

9. An image forming system comprising:
an image forming apparatus that forms an image on a recording medium; and
the post-processing device according to claim 2 that executes post-processing on the recording medium on which the image forming apparatus forms the image.

10. An image forming system comprising:
an image forming apparatus that forms an image on a recording medium; and
the post-processing device according to claim 3 that executes post-processing on the recording medium on which the image forming apparatus forms the image.

11. An image forming system comprising:
an image forming apparatus that forms an image on a recording medium; and
the post-processing device according to claim 4 that executes post-processing on the recording medium on which the image forming apparatus forms the image.

12. An image forming system comprising:
an image forming apparatus that forms an image on a recording medium; and
the post-processing device according to claim 5 that executes post-processing on the recording medium on which the image forming apparatus forms the image.

13. An image forming system comprising:
an image forming apparatus that forms an image on a recording medium; and
the post-processing device according to claim 6 that executes post-processing on the recording medium on which the image forming apparatus forms the image.

14. An image forming system comprising:
an image forming apparatus that forms an image on a recording medium; and
the post-processing device according to claim 7 that executes post-processing on the recording medium on which the image forming apparatus forms the image.
